(19) United States
(12) Patent Application Publication
(10) Pub. No.: US 2016/0078072 A1
(43) Pub. Date: Mar. 17, 2016

(54) TERM VARIANT DISCERNMENT SYSTEM AND METHOD THEREFOR

(71) Applicants: Jeffrey D. Saffer, Las Vegas, NV (US); Vicki L. Burnett, Las Vegas, NV (US)

(72) Inventors: Jeffrey D. Saffer, Las Vegas, NV (US); Vicki L. Burnett, Las Vegas, NV (US)

(21) Appl. No.: 14/484,130

(22) Filed: Sep. 11, 2014

(51) Int. Cl. G06F 17/30; G06F 17/22; G06F 17/27

(52) U.S. Cl. CPC G06F 17/30321; G06F 17/277; G06F 17/2276; G06F 17/3053

(57) ABSTRACT

A term variant discernment system identifies terms in content and executes one or more discernment processes to determine a meaning for each term. An ID is assigned to each term based on its meaning, with terms and their variant terms being assigned a distinct ID when they have different meanings and with terms and their variant terms being assigned the same ID when they have the same meaning. The terms and variants can then be individually queried via a query even though the terms and their variants may have the same spelling, abbreviation, or other characteristics.

### BACKGROUND OF THE INVENTION

1. Field of the Invention

The invention generally relates to indexing, searching, and data mining information and in particular to systems and methods for the same that are capable of handling term variants.

2. Related Art

Generally, when a system performs a search or information retrieval from an information store, the search is insensitive to variations in how a term is written. One example of relevant term variants is due to differences in case. For instance, a search of textual content for “po” will find “po”, “PO”, “Po” and “pO”—even though each variant may have a different meaning. This insensitivity forces the user to weed through the results to find what they really want, although in many cases, this problem is simply overlooked.

There are two existing, but highly limited, methods for overcoming the problems of case-insensitive searching. One method as described by Dole (U.S. Pat. No. 7,730,062) is to index terms in a case-sensitive manner and then search in a case-sensitive manner. This is a direct solution, but fails to provide sufficient discrimination. Another method is to execute a case-insensitive search and then apply a post-filter to eliminate records that contain the search term case variants that do not match the search term as entered (https://code.google.com/p/case-sensitive-search/). Both of these alternatives fail to account for contextual information that can be critical for understanding whether two terms are alike or different. Furthermore, neither approach extends to term variants beyond case differences (such as the use of an extended character set), nor can they deal with the reverse problem of identical terms having different meanings.

From the discussion that follows, it will become apparent that the present invention addresses the deficiencies associated with the prior art while providing numerous additional advantages and benefits not contemplated or possible with prior art constructions.

### SUMMARY OF THE INVENTION

The object of the term variant discernment system herein is to provide an intelligent method for accessing relevant information—for searching, retrieval, data mining, and related processes—that directly accounts, not only for case variants, but all other terms variants in a contextually intelligent manner.

As discussed further below, a term variant discernment system may have a variety of configurations. For instance, in one exemplary embodiment, a term variant discernment system comprises one or more processors that execute instructions to identify a term and a variant of the term in some content, determine a meaning of the term and its variant, and either assign a single ID to both the term and its variant or assign distinct IDs to the term and its variant based on the determined meaning of the term and its variant. The term variant discernment system also includes one or more storage devices storing the term and its variant and their assigned IDs, and one or more communication interfaces that receive one or more queries from a user.

The processors also execute instructions to identify one or more query terms in the queries, determine a meaning of the query terms, assign a new ID to the query terms if their meaning differs from that of the term and its variant, and assign an existing ID to the query terms if their meaning is the same as that of the term or its variant.

The meaning of the term and the variant may be determined through statistical analysis, a dictionary lookup, one or more predefined rules, contextual analysis, and the like. The meaning of the term and the variant may also or alternatively be determined through a weighted combination of one or more discernment processes.

The term variant discernment system may also comprise a local or remote display device. In such case, the term, alone or in context of other information, may be presented on the display device as a result of the query if its ID matches an ID of the query terms, and the variant may be presented on the display device as a result of the query if its ID matches an ID of the query terms. In this manner, a queried term can be displayed/presented when found.

In another exemplary embodiment, a term variant discernment system comprises at least one processor that executes instructions to identify a plurality of terms and one or more variants of each term in some content, and determine a meaning for each of the plurality of terms and their variants. For each of the plurality of terms, a single ID is assigned to both the term and its one or more variants or distinct IDs are assigned to the term and its one or more variants based on the determined meaning of the term and its one or more variants. In this manner, terms and their variants are assigned the same ID if their meanings are the same, and different IDs if they differ in meaning. The processor may also execute instructions to store the IDs of the plurality of terms and their one or more variants in a storage device.

The processor also executes instructions to identify one or more query terms in a query and determine a meaning for each of the query terms. For each of the query terms that have the same meaning as one of the plurality of terms, the same ID is assigned. For each of the query terms that do not have the same meaning as one of the plurality of terms a new ID is assigned. In this manner, query terms can be precisely matched to corresponding content terms, even where there would otherwise be some ambiguity as to the definition of a query term. The query may be received at the processor via a communication device.

The meaning of the plurality of terms and their one or more variants may be determined by a weighted discernment process selected from the group consisting of statistical analysis, contextual analysis, rule-based analysis, dictionary lookup, or other related methods. Also, a display device or client device may present one or more of the plurality of terms that have the same ID as that of at least one of the query terms. Alternatively or in addition, a display device or client device may present the variants that have the same ID as that of at least one of the query terms.

Various methods relating to discernment of term variants are disclosed herein as well. For instance, in one exemplary embodiment, a term variant discernment system implemented method for discerning terms and their variants comprises identifying a term and a first variant and a second variant from some content, and determine a meaning for the term and its first variant and second variant using one or more discernment processes executed on one or more processors.

An ID is assigned to the term based on its meaning. This ID is also assigned to the first variant, which has the same meaning as the term. A new ID is assigned to the second variant, which has a different meaning as the term and first variant. The meaning of the terms, the first variant, and the second variant are determined by a weighted discernment process selected from the group consisting of statistical analysis, contextual analysis, rule-based analysis, and dictionary lookup. The term and its first variant and second variant are stored along with their assigned IDs on a storage device;

A query comprising one or more query terms may then be received, such as via a communication device, with each of the query terms have a meaning. The term variant discernment system assigns the term's ID to each of the query terms that have the same meaning as the term, wherein the term's ID is retrieved from the storage device; assigns the second variant's ID to each of the query terms that have the same meaning as the second variant, wherein the second variant's ID is retrieved from the storage device, and assigns a new ID to each of the query terms that remain.

The term and the first variant may be presented on a display device or client device when the query terms have IDs matching the ID of the term. Similarly, the second variant may be presented on a display device or client device when the query terms have IDs matching the ID of the second variant.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a flow diagram illustrating operation of an exemplary term variant discernment system when finding relevant information;

FIG. 2 is a flow diagram illustrating operation of an exemplary term variant discernment system when handling case variants;

FIG. 3 is a flow diagram illustrating operation of an exemplary term variant discernment system when handling different spellings;

FIG. 4 is a flow diagram illustrating operation of an exemplary term variant discernment system when handling polysemic terms;

FIG. 5 is a block diagram illustrating an exemplary term variant discernment system in an environment of use;

FIG. 6 is a block diagram illustrating an exemplary term variant discernment system; and

FIG. 7 is a block diagram illustrating modules of an exemplary term variant discernment system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

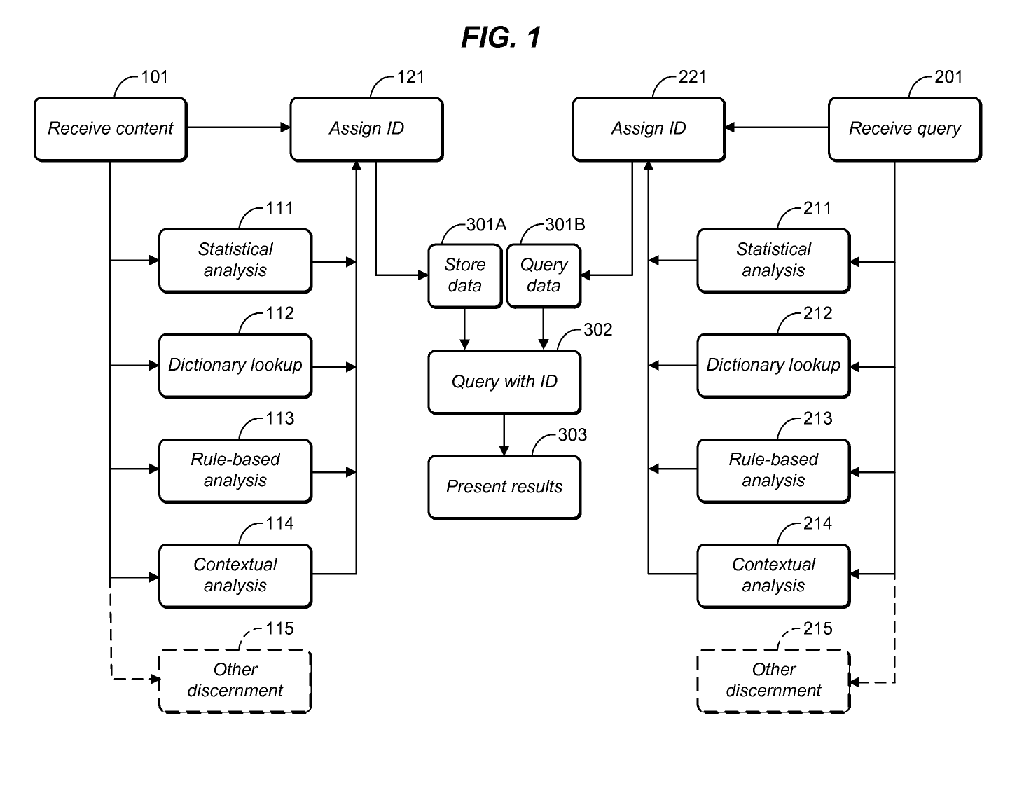

An exemplary term variant discernment system will now be disclosed with regard to the flow diagram of FIG. 1. As the terms from one or a plurality of information sources are received and identified at a step 101 for any processing, including indexing, they are assigned a unique identifier code, as shown at a step 121. Such a code may be sequentially assigned codes (such as identification numbers), codified identifiers (such as from a lookup table), derived from the term itself, or some combination of methods.

Some terms encountered at step 101 may contain characters other than ASCII lowercase letters. Such Term Variants may be due to capitalization as in:
act (performing)
AcT (acceleration time, among others)
ACT (Artemisinin-based Combination Therapy, among others)

Other terms may have variants due to Unicode, including multiple alphabets, as in:
Munster (more likely a variant spelling of the cheese)
Münster (probably the German city, which is not related to the cheese)

In contrast, the variants
b-actin
β-actin

are both likely to refer to the same protein.

Variants may also be numeric in nature from the use of different representations within alphanumeric or wholly numeric terms, as in:
twelve
XII

The above two terms may or may not be equivalent depending on context.

Many other types of variants, including but not limited to those that cover multiple characters in one variant but only one character is another or hyphenation differences, are possible. A “term” may also include multiple words that represent a single conceptual entity (e.g., “traffic light” or “United States of America” may each be individual terms).

For terms that contain variant representations, each variant could be directly assigned a different identification code at step 121. This alone enables use of the information content in a more discriminating manner than treating all similar terms (such as all case variants) the same.

In most cases, however, it is desirable to determine whether the different variants of a term imply a difference in meaning (e.g., true capitonyms) or not (aliases). Using capitalization differences as an example, “aids” and “AIDS” are likely to have a different meaning. In contrast, sometimes a capital letter may be used for presentation purposes (such as a majuscule), for “shouting”, or simply because it is the first word in a sentence—yet not imply a conceptual difference.

Ideally, all the different types of term variants require their meaning to be discerned to determine if they are different or the same. Methods for this discernment include, but are not limited to the following.

Statistical Analysis: In some information collections, statistical methods—including overall term frequencies, co-occurrence frequencies with other terms, and more—can be used to assess the likelihood of one meaning or another for a particular variant.

Lookup in Dictionary: In some cases, such as information specific to a narrow field, it may be appropriate to use a dictionary of sorts to pre-define term variants as one definition or another.

Rule-based Methods: Rule-based methods can be applied in many circumstances to discern meaning for term variants. These methods include, but are not limited to techniques such as natural language processing (NLP), part-of-speech determination, or simple rules such as position in a sentence (where the first word, for example, may be capitalized without implying a different meaning).

Contextual Analysis: Contextual analysis may be rule-based, but also comprises additional methods such determination of topical terms in various sections of a document to aid is assigning a particular meaning to a term variant.

Other Discerning Processes: There are other approaches for discerning meaning of terms, and different processes can be applied as needed.

Given the availability of the discernment processes, in FIG. 1, after a term is identified, it may pass through steps 111, 112, 113, 114, one or more other discernment steps 115, or various subsets thereof to determine if the meaning of the variant is different from other variants. Steps 111, 112, 113, 114, and 115 may also be used in any combination to derive an overall assessment of meaning Whether these processes are utilized singly or in combination, the resulting information can be used at step 121 to assign the identification number to each meaning. In process 121, the information from the discernment steps 111, 112, 113, 114, and 115 might be integrated, or priority might be given to some processes over others.

Once an identification codes are assigned, those codes can be added, used, or both in a data store at a step 301A, including an indexed form of a data store. These identification codes could be used for data mining purposes as well as search and retrieval.

For some embodiments including search and retrieval, the query term would be identified at a step 201 and go through identification code assignment, as shown at a step 221 either directly or via definition-determination steps 211, 212, 213, and 214—alone or in any combination. Assignment of the identification code is coordinated or standardized against the content term identification codes used at step 121.

Subsequently, the query against the data store at a step 302 would be by the identification code(s) for the query term(s), rather than using the term itself. The resulting information, depending on purpose, might then reverse-translate the identification code in order to present a user with readable information at a step 303.

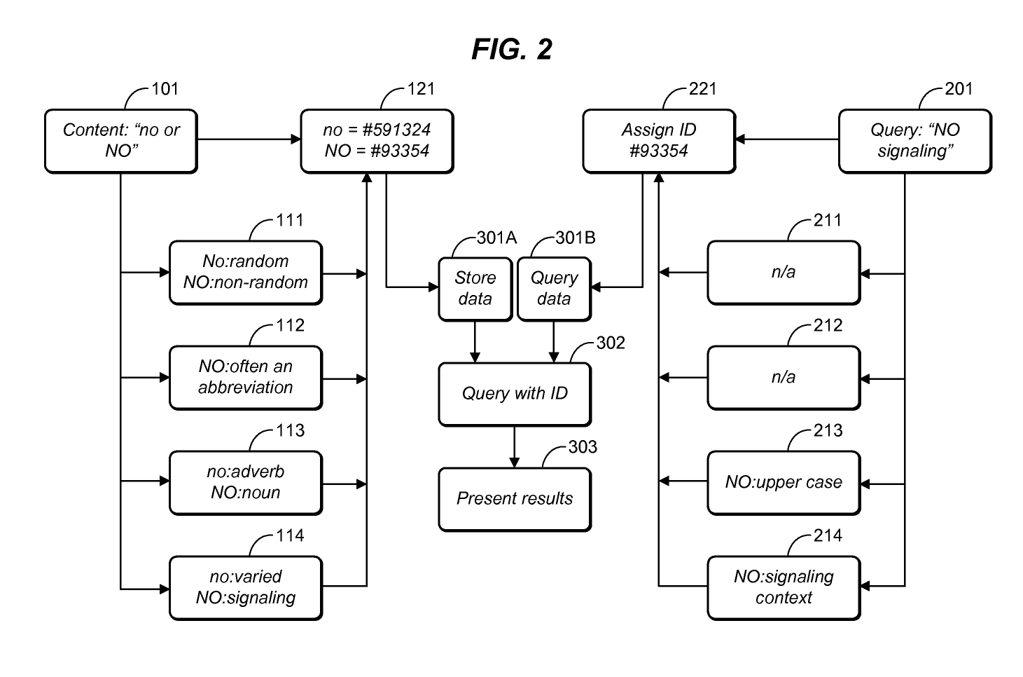

Various examples will now be described with regard to FIGS. 2-4. In FIGS. 2-4, though the step labels contain text showing particular operations of the term variant discernment system rather than step labels (such as found in FIG. 1), it will be understood that like reference numerals designate corresponding steps as disclosed above with regard to FIG. 1.

As an example of the application of the term variant discernment system, consider the following with reference to FIG. 2. In an exemplary input data set, the terms “no” and “NO” are encountered at a step 101. Each term is run through one or more discernment processes. As shown, the discernment processes may occur at one or more steps, such as Statistical Analysis (step 111), comparison to Dictionary entries (step 112), Rule-based Analysis (step 113), and Contextual Analysis (step 114). If none of the discernment processes provides an indication that the two variants of “no”, one lowercase and one uppercase, are different, then the Identification Number Assignment process would assign the same ID number to both forms at step 121. If one or more of the discernment processes provides information that the two forms should not be identified as the same, the Identification Number Assignment process would assign a different ID number to each form. For some content, it may be advantageous to always assign different IDs to each case variant; this is equivalent to adding a discernment process which is simply case detection.

However, in this example, there is information from the discernment processes that there is likely a difference in meaning between “no” and “NO”. Although it will not always be the case, for the purposes of this illustration, all four of the discernment processes provide useful information.

The Statistical Analysis informs the system that the two case variants have different distributions (or perhaps different co-occurrence frequencies with other terms). The Dictionary informs the system that the capitalized form of the term is known to have a different meaning in some uses. Rule-based Analysis informs the system that the part of speech for each variant is different. Finally, Contextual Analysis shows that the capitalized term is preferentially used in specific contexts. Again, in other cases not all discernment processes would give useful output, and the choice of discernment processes may differ.

The information from the discernment processes is then provided to the ID assignment process, shown at step 121, where using any number of methods known to those versed in the art, it is determined that each case form (“no” or “NO”) should be assigned different identification numbers. For example, if three of the four methods indicate the term variants are different, that preponderance of evidence could be used at step 121 to assign different identification numbers. These ID numbers, along with other information that might include the term itself, its context, or metadata about the document source is then provided to a Data Store at a step 301A, which may be indexed as described above.

With the Data Store created, the user in this example enters a query for “NO signaling”, which may be received at a step 201. Each of those terms is fed to the desired discernment processes, such as shown at steps 211, 212, 213, 214. In this example, output from the dictionary lookup of step 212 and the Context Analysis of step 214 provide information about the capitalized “NO”. At a step 221, the ID assignment process then recognizes that the ID for this term should be #93354. That ID, along with the ID for signaling, is then used to interrogate the Data Store at step 301B to find relevant data records.

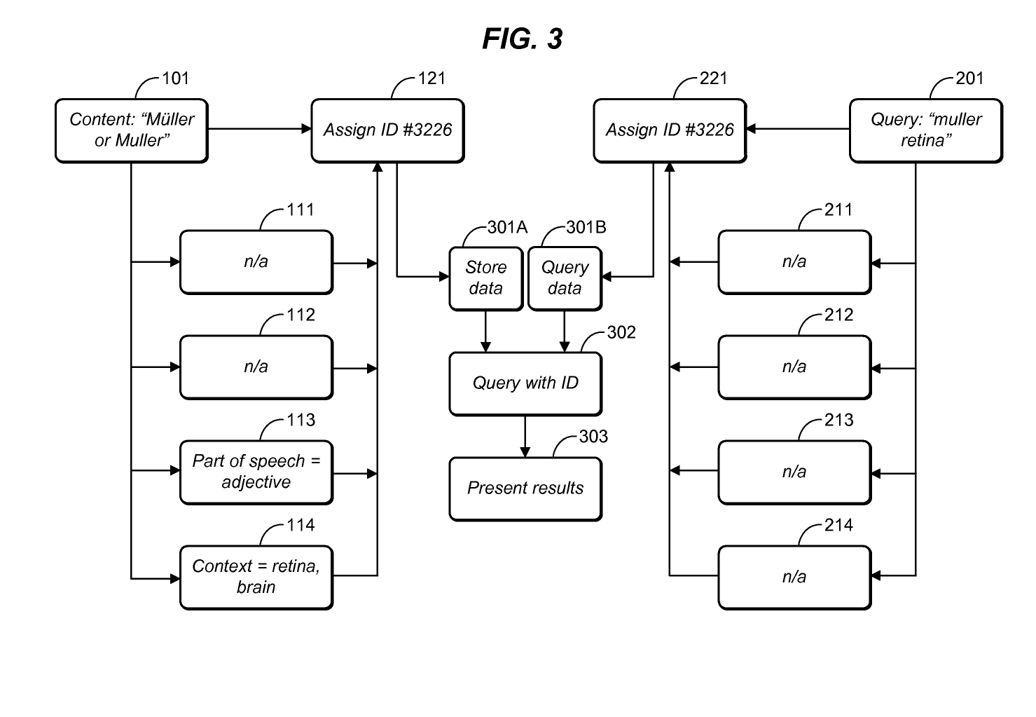

The above example focused on case-variants. A different type of example is illustrated in FIG. 3. In this case, a body of content identified at step 101 contains the term “Müller” (e.g., a type of glial cell). This term is often written as “Muller” (without the umlaut), especially in older ASCII-based documents. As each of these variants is to be entered into a data store, the term would go through discernment processes, as shown in steps 111, 112, 113, and 114. Rule-based analysis at step 113 provides a part of speech as adjective for both “Müller” and “Muller”. The contextual analysis finds that both variants are used in context of “retina” and “brain”. In this example, the statistical analysis at step 111 and the dictionary lookup at step 112 have no useful output. The ID assignment process at step 121 combines the output from the discernment processes and determines (e.g., by the weight of evidence or other algorithm) that both “Muller” and “Muller” are likely to have the same meaning and hence assigns the same ID, ID #3226 for purposes of this example. The first time one of the terms is processed, the ID is determined and then the same ID is assigned to subsequent occurrences of the variant.

At step 301, the data store can thereby store the given ID for both “Müller” and “Muller”, in most cases along with the term, its context, and other metadata about the respective term, the document it came from, etc. Thus, a search for ID=3226 would find records (or individual data entries) that contain either “Müller” and “Muller”. In another set of documents, such as a corpus about mortar and pestles, “muller” and “Müller” might be assigned different IDs.

Now, when the user enters a query all the terms are similarly run through the discernment processes, as shown at steps 211, 212, 213, and 214. Supposing the user query was “Muller retina”, a contextual analysis process at step 214 could provide an output that causes the query term to be assigned an ID that matches the terms with the same meaning from the original corpus (i.e., ID #3226), at step 221. The actual search process then uses the ID #3226 to find documents that contain the same ID at step 302. The information about the documents that contain ID #3226 are then presented to the user at a step 303. The result is that an ID search has found both related variants rather than treating “Müller” and “Muller” as separate entities.

It is contemplated that similar methods can be used to delineate between different meanings (polysemy) of identical terms. For example, in the sentence, “A bear was seen in the woods.” the term “bear” likely represents an ursine mammal, whereas in the sentence, “To bear the weight required additional struts.” the term “bear” likely represents the concept of support. Using statistical analysis, dictionary lookup, rule-based methods, and contextual analysis—alone or in any combination, the different meanings of “bear” could be discerned and each different meaning assigned a unique identification code at step 121.

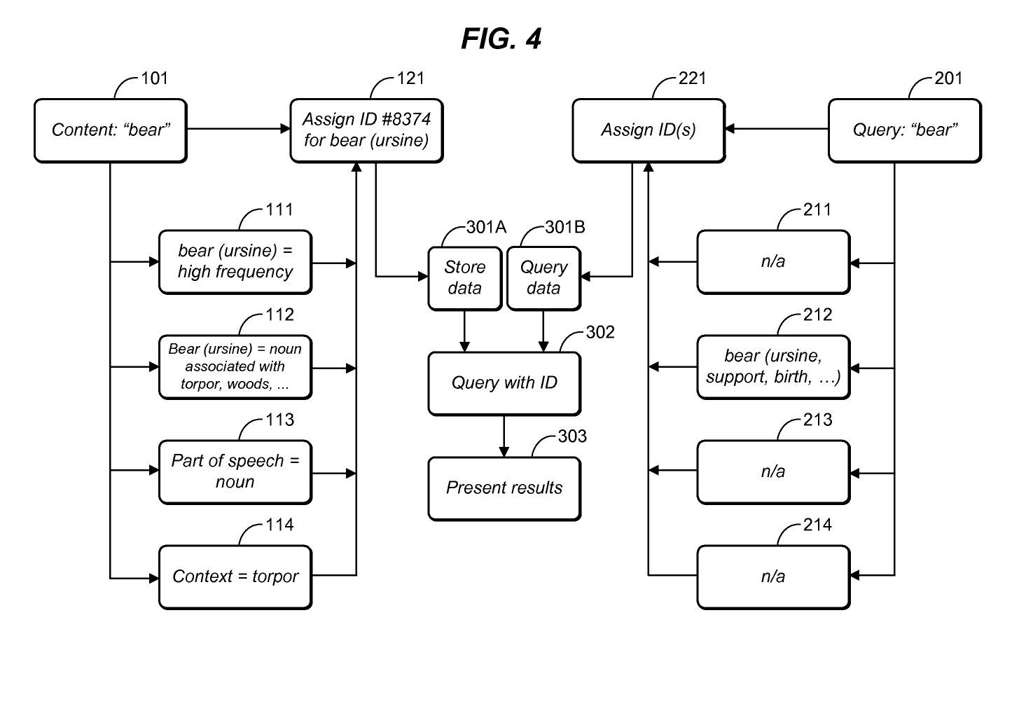

As an illustration, consider the following example as illustrated in FIG. 4. In a corpus, several documents are found to contain the term “bear”. When this term is encountered in Document 1, the document (or the relevant section thereof) is shuttled through one or more discernment processes at step 111 (where, for example, it is found that “bear”=“ursine” is the most likely usage in a corpus about, say, carnivores), at step 112 (where, for example, a dictionary tells us the term “bear” (ursine) is a noun that is often associated with terms such as torpor or woods), at step 113 (where, for example, the part of speech for the encountered instance of “bear” is a noun”, and at step 114 (where, for example, the encountered “bear” is used in the context of “torpor”.

The information from the discernment processes of steps 111, 112, 113, 114 or various subsets/combinations thereof, is fed to the ID assignment process at step 121, which then determines this instance of “bear” refers to the ursine mammal and assigns it an ID, ID #8374 for purposes of this example, distinct from other meanings of “bear”. For the corpus, additional instances of “bear” with the ursine meaning would be assigned the same ID. Other instances of “bear”, even in the same document may not have the same meaning and hence would be assigned a different ID. For other terms, it is noted that the specific processes used for discernment at one or more of steps 111, 112, 113, 114 and subsequent assignment of a unique ID at step 121 may be different.

Now, a user enters a query and each term is identified at step 201 for processing via the various discerning processes at one or more of steps 211, 212, 213, and 214. For some queries, such as “bear torpor”, there may be sufficient information within the query per se for the discerning processes to provide useful output. For example, statistical or rule based analysis of “bear torpor” may be sufficient alone to discern the meaning of the term for ID assignment purposes. In such case not all the discernment processes may be needed or utilized.

In the case of “bear”, there may be a dictionary that lists the different forms and the user may be presented an interface to choose the relevant one thus enabling the correct ID to be assigned at step 221. If there are no discerning processes that provide useful information, another interface (or similar method) could be provided based on the various meaning variants of “bear” in the data store that allows the user to provide input to guide the search. For example, the user may select a particular form of a term via this other interface.

The same approach as disclosed above with regard to FIGS. 1-4 can be used to assign the same ID, if desired, to different tenses for verbs and to singular and plural forms of nouns. In general, the term variant discernment system can be applied to any terms where meaning—or other attributes—are desired to convey equivalency or differences.

The invention described has significant benefits over existing methods where the index itself is case-sensitive and the search is case-sensitive. Not only are the approaches described more broadly applicable to all types of term variants, but additional steps can be employed to determine whether the different variants indeed imply a different meaning. Furthermore, the same processes can be applied in general for disambiguation of terms that have multiple and distinct concepts.

The approaches described also have significant benefits over existing methods where the searching is done in a case-insensitive manner followed by post-filtering of specific capitalization forms. As above, the current invention is more broadly applicable. Determining the actual conceptual intent of a term as described in the current invention enables disambiguation for same case terms. For example, NO often occurs in the literature as a representation for “number”, but it can also mean “nitric oxide” and more. Simply filtering after the fact does not help make that distinction. Finally, post-filtering can require significant processing time whereas a direct search of a data store using identification codes can be very fast.

Although the examples given above refer to text documents, the term variant discernment system can equally be applied to any content in any form (for example, tabular data). Although the invention has been described with regard to specific structural features and methods, it is the intent that the invention defined by the accompanying claims is not necessarily limited to the specific features or methods described. Rather, the specific features and methods are disclosed as examples of implementing the invention claimed.

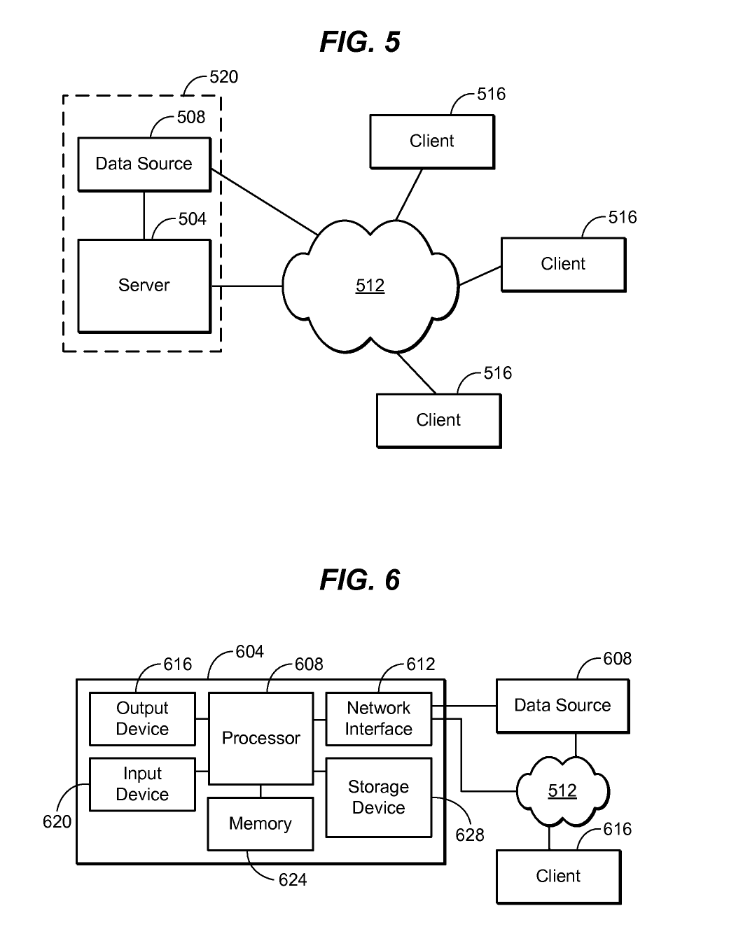

FIG. 5 is a block diagram illustrating an exemplary term variant discernment system 520 in an exemplary environment of use. As can be seen, the term variant discernment system 520 may comprise one or more servers 504 and one or more data sources 508. It is noted that data source(s) 508 need not be part of a term variant discernment system in every embodiment. For instance, one or more data sources 508 may be third party data sources, such as external databases or data storage devices accessible to the pair-based valuation system 520.

A server 504 and data source 508 may communicate via one or more communication links, which may be wired or wireless and which may utilize various communication protocols now known or later developed. In addition or alternatively, it is contemplated that a server 504 and data source 508 may communicate via one or more networks 512, such as to allow the server and data source to communicate without a direct communication link.

As will be described further below, a user may interact with or otherwise access the term variant discernment system 520 directly, such as through one or more input and output devices. Alternatively or in addition, a user may remotely access a pair-based valuation system 520 via a client device 516. As shown in FIG. 5 for example, one or more client devices 516 may communicate with a term variant discernment system 520 to provide access thereto. Such communication may occur via one or more communication links and/or one or more networks 512. Some exemplary client devices 516 include desktop computers, laptops, smartphones, PDAs, and tablets.

FIG. 6 is a block diagram illustrating an exemplary server 504 and components thereof. As can be seen, a server 504 may comprise one or more processors 608, memory devices 624, network interfaces 612, and storage devices 628. A processor 608 may be a microprocessor, microcontroller, CPU, or other circuitry that executes one or more instructions to provide the functionality disclosed herein. A processor 608 may also control or communicate with other components of a server 504 or other device to provide the functionality disclosed herein. For example, a processor 608 may receive property data.

The instructions a processor 608 executes may be hardwired into the processor itself. Alternatively or in addition, the instructions may be stored on a storage device 628, where the instructions may be retrieved for execution by a processor 608. It is contemplated that a memory device 624 may be used to cache some or all of the instructions. In addition, a memory device 624, storage device 628 or both may store values or variables used during execution of the instructions such as to store constant or calculated values resulting from the process of generating an adjustment and/or associated adjustment information. As alluded to above, a memory device 624 may be RAM or similar memory while a storage device 628 may be a hard drive with magnetic, flash or optical media that provides more permanent storage. The media may be integral to the storage device 628 or may be removable.

One or more storage devices 628 may also be used to store adjustment information, property data or both. It is contemplated that a storage device 628 may be a local storage device or may be located remote from the server 504 in various embodiments of the term variant discernment system. Data storage may be implemented via one or more databases (e.g. PostgreSQL, MySQL, Mongo DB, etc.) or to network data stores (e.g. Amazon S3).

A network interface 612 or other communication device will typically be included to allow communication with one or more external or remote devices. As shown for example, a network interface 612 may connected to and communicate with a data source 508, a client 516 or both, either via a direct communication link or via one or more networks 512. As described above, a network interface 612 may utilize a variety of communication protocols and communicate via a wired or wireless communication link. It is noted that a communication device may also be used to communicate with a remote storage device 628.

The term variant discernment system may permit user interaction or access in various ways. As described briefly above, a server 504 of the term variant discernment system 520 may optionally include one or more output devices 616, such as display screens, speakers, lights, etc. to present a user interface, status, or other information to a user. One or more input devices 620, such as keyboards, mice, touchscreens, touchpads, etc. may optionally be provided to receive user input, such as to interact with a user interface of the server 504. A user interface may also be presented via a remote device, such as a client device 516. A client device 516 may receive screens or other elements of a user interface from a server 504, such as via the server's network interface 612.

In one embodiment for example, a user interface may present multiple definitions of a particular term for selection by a user. Alternatively or in addition, a user interface may present one or more dialog or input boxes or the like to receive a user's query. One or more text boxes or the like may be presented to show the results of a query or other information.

Though described above with regard to physical server hardware, it is contemplated that a server 604 may also or alternatively be implemented as a virtualized server. In such embodiments, a processor 608, memory device 624 and other components of a server 504 may be present in virtual form.

Referring back to FIGS. 1-4, during operation of one exemplary term variant discernment system 520, one or more network interfaces 512 receive input data from one or more data sources so that one or more processors 508 may identify the terms therein at step 101. One or more processors 508 can then analyze the terms by executing one or more discernment processes, such as described with regard to steps 111, 112, 113, 114, and 115. One or more processors 508 may also be used to assign IDs to the terms thereafter, at step 121.

Similarly, one or more processors 508 may be used to execute discernment processes, such as disclosed with regard to steps 211, 212, 213, 214, and 215, and to assign IDs, as disclosed with regard to step 221 for a query terms received and identified at step 201. The query terms may be identified by one or more processors 508 as well. It is noted that an input device 620 or client device 516 may receive the query from a user and communicate the query to the term variant discernment system. A storage device 528 may be used to store terms and their assigned IDs for subsequent retrieval, such as disclosed above with regard to steps 301 and 302. An output device 616, such as a display screen, or client device 516 may be used to present information retrieved at step 303.

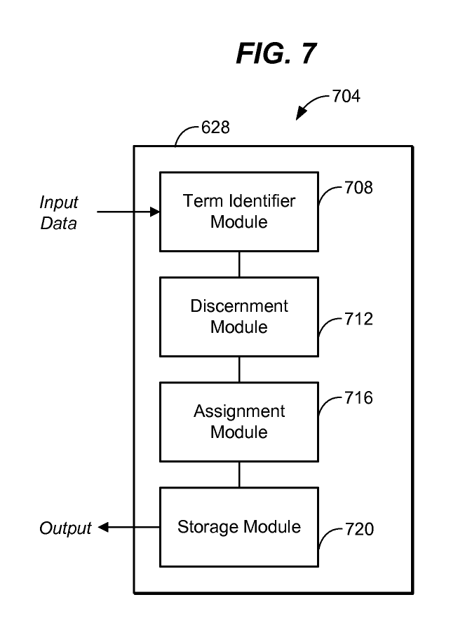

FIG. 7 is a block diagram illustrating exemplary machine-readable code 704 comprising instructions that provide the functionality of a term variant discernment system when executed. As can be seen, the instructions of the machine-readable code 704 may be organized or grouped into one or more modules. In the exemplary embodiment of FIG. 7, the machine-readable code comprises a term identifier module 708, discernment module 712, storage module 716 and presentation module 720. The machine-readable code may be stored on a storage device 628, which may utilize various data storage technologies now known or later developed, including magnetic, flash, or optical storage technologies.

In one or more embodiments, a term identifier module 708 comprises instructions to receive input data from a data source and identify one or more individual terms therein (i.e., feature information values). This may occur in various ways. For example, a term identifier module 708 may identify delimiters (e.g., spaces, commas, or other characters) within input data that indicate the location of individual terms.

A discernment module 712 may comprise instructions to provide the discernment processes disclosed above. For example, a discernment module 712 may include instructions to provide statistical analysis, dictionary lookup, rule-based analysis, contextual analysis, or various subsets/combinations thereof. In operation, a discernment module 712 may receive other input data in addition to identified terms to provide a context through which a ID can be properly assigned to the term, as discussed above with regard to steps 111, 112, 113, 114, and 115. One or more discernment modules 712 may be provided.

An assignment module 716 may comprise instructions to assign an ID to a term. As described above, the ID that is assigned to a term will typically depend on the result(s) of one or more discernment processes, with the aim being to assign different IDs to term variants having different definitions or meaning, and to assign the same ID to term variants having the same definition or meaning.

Typically, an assignment module 716 will receive input from one or more discernment modules 712 in order to properly assign an ID to a term. For terms with multiple possible definitions or meanings, this input will indicate which of the possible definitions the term is associated with. An assignment module 716 may weigh input from one or more discernment modules 712 and use the “best” indicator or weighted evidence to assign an ID to a term. For instance, one or more discernment modules 712 may report a confidence level (numerically or on another weighted scale) of the definition or meaning of a particular term.

An assignment module 716 may utilize this confidence to assign an ID to the term, such as by making an ID assignment according to the single highest confidence level, or a confidence level above a predefined threshold. Multiple confidence levels may be evaluated as well. In such case, for example, an ID may be assigned for a particular definition if multiple confidence levels for the particular term definition are above a predefined threshold.

An assignment module 716 may also query a storage device, such as through a storage module 720 or directly, to retrieve any already assigned ID for a particular term. In this manner, an assignment module 716 can retrieve previously assigned IDs for assignment to new terms as they are encountered. For instance, if “NO” with an ID of #44567 is determined to have the same definitions as “no”, the ID for “NO” can be retrieved and assigned to “no.”

A storage module 720 may comprise instructions to store and retrieve information from a storage device. In addition, a storage module may format information for storage or after retrieval. For instance, a storage module 720 may store terms associated with their assigned IDs in a database or other record on a storage device. Likewise, a storage module 720 may also retrieve information, such as terms and their assigned IDs, from a storage device for subsequent transmission or use by the term variant discernment system.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A term variant discernment system comprising:
one or more processors that execute instructions to:
identify a term and a variant of the term in some content;
determine a meaning of the term and its variant; and
assign a single ID to both the term and its variant or assign distinct IDs to the term and its variant based on the determined meaning of the term and its variant;
one or more storage devices storing the term and its variant and their assigned IDs; and
one or more communication interfaces that receive one or more queries from a user, wherein the one or more processors also execute instructions to:
identify one or more query terms in the one or more queries;
determine a meaning of the one or more query terms;
assign a new ID to the one or more query terms if their meaning differs from that of the term and its variant; and
assign an existing ID to the one or more query terms if their meaning is the same as that of the term or its variant.

2. The term variant discernment system of claim 1, wherein the meaning of the term and the variant are determined through statistical analysis.

3. The term variant discernment system of claim 1, wherein the meaning of the term and the variant are determined through a dictionary lookup.

4. The term variant discernment system of claim 1, wherein the meaning of the term and the variant are determined through one or more predefined rules.

5. The term variant discernment system of claim 1, wherein the meaning of the term and the variant are determined through contextual analysis.

6. The term variant discernment system of claim 1, wherein the meaning of the term and the variant are determined through one or more weighted discernment processes.

7. The term variant discernment system of claim 1 further comprising a local or remote display device, wherein the term is presented on the display device as a result of the query if its ID matches an ID of the one or more query terms, and the variant is presented on the display device as a result of the query if its ID matches an ID of the one or more query terms.

8. A term variant discernment system comprising at least one processor that executes instructions to:
identify a plurality of terms and one or more variants of each term in some content;
determine a meaning for each of the plurality of terms and their variants; and
for each of the plurality of terms, assign a single ID to both the term and its one or more variants or assign distinct IDs to the term and its one or more variants based on the determined meaning of the term and its one or more variants;
identify one or more query terms in a query and determine a meaning for each of the one or more query terms;
for each of the one or more query terms that have the same meaning as one of the plurality of terms, assign the same ID; and
for each of the one or more query terms that do not have the same meaning as one of the plurality of terms assign a new ID.

9. The term variant discernment system of claim 8, wherein the at least one processor also executes instructions to store the IDs of the plurality of terms and their one or more variants in a storage device.

10. The term variant discernment system of claim 8, wherein the query is received at the at least one processor via a communication device.

11. The term variant discernment system of claim 8, wherein the meaning of the plurality of terms and their one or more variants are determined by a weighted discernment process selected from the group consisting of statistical analysis, contextual analysis, rule-based analysis, and dictionary lookup.

12. The term variant discernment system of claim 8, wherein the content is a text document.

13. The term variant discernment system of claim 8 present via a display device or client device one or more of the plurality of terms that have the same ID as that of at least one of the one or more query terms.

14. The term variant discernment system of claim 8 present via a display device or client device the one or more variants that have the same ID as that of at least one of the one or more query terms.

15. A term variant discernment system implemented method for discerning terms and their variants comprising:
identifying a term and a first variant and a second variant from some content;
determine a meaning for the term and its first variant and second variant using one or more discernment processes executed on one or more processors;
assign an ID to the term based on its meaning;
assign the ID to the first variant;
assign a new ID to the second variant;
store the term and its first variant and second variant along with their assigned IDs on a storage device;
receive a query comprising one or more query terms, wherein each of the query terms have a meaning;
assign the term's ID to each of the one or more query terms that have the same meaning as the term, wherein the term's ID is retrieved from the storage device;
assign the second variant's ID to each of the one or more query terms that have the same meaning as the second variant, wherein the second variant's ID is retrieved from the storage device; and
assign a new ID to each of the one or more query terms that remain.

16. The method of claim 15 further comprising presenting the term and the first variant on a display device or client device when the one or more query terms have IDs matching the ID of the term.

17. The method of claim 15 further comprising presenting the second variant on a display device or client device when the one or more query terms have IDs matching the ID of the second variant.

18. The method of claim 15, wherein the meaning of the terms, the first variant, and the second variant are determined by a weighted discernment process selected from the group consisting of statistical analysis, contextual analysis, rule-based analysis, and dictionary lookup.

19. The method of claim 15, wherein the meaning of the one or more query terms are determined by a weighted discernment process selected from the group consisting of statistical analysis, contextual analysis, rule-based analysis, and dictionary lookup.

20. The method of claim 15 further comprising receiving the query via a communication device.
